(19) United States
(12) Patent Application Publication
(10) Pub. No.: US 2008/0070630 A1
(43) Pub. Date: Mar. 20, 2008

(54) MOBILE PHONE AND INFORMATION STORE CARD DRAWING MECHANISM

(75) Inventors: Hui ZHANG, Suzhou (CN); Shun-Cai HE, Suzhou (CN)

Correspondence Address: QUINTERO LAW OFFICE, PC, 2210 MAIN STREET, SUITE 200, SANTA MONICA, CA, 90405, US

(73) Assignees: QISDA CORPORATION, TAOYUAN COUNTY (TW); BENQ CORPORATION, TAIPEI (TW)

(21) Appl. No.: 11/856,502

(22) Filed: Sep. 17, 2007

(30) Foreign Application Priority Data
Sep. 18, 2006 (TW) TW95134427

(51) Int. Cl. H04M 1/00

(52) U.S. Cl. 455/558

(57) ABSTRACT

An information store card drawing mechanism for a mobile device includes a main body, a drawing portion disposed on the main body, a hook extending from the main body and the mobile device, and an elastic element connecting the main body and the mobile device, and a track disposed on the mobile device. The main body is guide by the track. When the drawing portion is pulled from an original position, the main body slides along the track and the hook pushes and moves the information store card. When the drawing portion is released, the elastic element returns the main body to the original position.

### BACKGROUND OF THE INVENTION

1. Field of the Invention

The present invention relates to an information store card drawing mechanism, and in particular relates to a subscriber identity module card (SIM card).

2. Description of the Related Art

Mobile phones are equipped with information store cards, such as a subscriber identity module card or a security digital card. A drawing mechanism for the information store card is important for the operation of the mobile phone.

FIG. 1 is an exploded view of a conventional mobile phone. A conventional mobile phone 100 comprises a front frame 10, a back cover 20, a battery 30 and an information store card 90. A battery room 12 is formed on the front frame 10 to accommodate a battery 30. A recess 14 is disposed on the battery room 12 to accommodate an information store card 90. A constraining element 18 is disposed on the recess 14 and an engaging element 16 is disposed on the front of the recess 14. FIG. 2 is a cross section of the recess 14. The engaging element 16 is a spring tab. When the information store card 90 is to be inserted into the recess 14, the engaging element 16 is pushed to allow the information store card 90 to enter the recess 14. When the information store card 90 enters the recess 14, the engaging element 16 is released. The engaging element 16 and the constraining element 18 position the information store card 90 in the recess 14.

When the information store card 90 is to be drawn out, the engaging element 16 must be pressed by one hand, and the information store card 90 is pushed forward by the other hand. As the information store card 90 is moved by the friction between the finger and the information store card 90, if the friction is not enough, the information store card 90 is not easily moved out. In addition, both hands must be used to draw the information store card 90.

### BRIEF SUMMARY OF INVENTION

An embodiment of an information store card drawing mechanism for a mobile device includes a main body, a drawing portion disposed on the main body, a hook extending from the main body and the mobile device, and an elastic element connecting the main body and the mobile device, and a track disposed on the mobile device. The main body is guided by the track. When the drawing portion is pulled from an original position, the main body slides along the track and the hook pushes and moves the information store card. When the drawing portion is released, the elastic element returns the main body to the original position.

The elastic element is formed by a wire with two ends joined to the main body and a middle portion joined to the mobile device. The wire has a first linear portion, a second linear portion and a ring portion connecting the first and second linear portions and positioned therebetween. The mobile device comprises a positioning element joined to the ring portion, and the main body has two through holes into which the first and second linear portions are inserted. The main body has a recess accommodating a part of the positioning element. The main body has two through hole into which two ends of the wire are inserted.

In another embodiment, the elastic element is formed by a wire with two ends joined to the mobile device and a middle portion joined to the main body. The wire has a first linear portion, a second linear portion and a ring portion connecting the first and second linear portions and positioned therebetween. The main body comprises a positioning element joined to the ring portion, and the mobile device has two through holes into which the first and second linear portions are inserted. The mobile device has a recess accommodating a part of the positioning element. The mobile device has two through hole into which two ends of the wire are inserted.

The main body is plate-shaped, and the drawing portion and the hook are disposed on opposite sides of the main body.

The main body has at least one groove and the mobile device has a protrusion engaging the groove, and the groove slides relative to the protrusion. The main body has a tail portion adjacent to the hook, and the mobile device has a channel. When the main body returns to the original position, the tail portion enters the channel.

A detailed description is given in the following embodiments with reference to the accompanying drawings.

### BRIEF DESCRIPTION OF DRAWINGS

The present invention can be more fully understood by reading the subsequent detailed description and examples with references made to the accompanying drawings, wherein:

FIG. 1 is a schematic view of a conventional mobile phone with an information store card;

FIG. 2 is a side view of recess of FIG. 1;

FIG. 3 is a perspective exploded view of a mobile phone according to the invention;

FIG. 4 is a perspective view of an embodiment of an information store card drawing mechanism according to the invention;

FIG. 5 is a perspective view of an elastic element according to the invention;

FIG. 6 is a schematic view showing the drawing mechanism disposed on a back cover of the mobile phone according to the invention;

FIG. 7 is a perspective view showing the information store card moved by the drawing mechanism;

FIG. 8 is a perspective view of another embodiment of the drawing mechanism of the invention;

FIG. 9 is a perspective view of another embodiment of the drawing mechanism of the invention;

FIG. 10a is a perspective view of another embodiment of the drawing mechanism of the invention; and

FIG. 10b is a perspective view of the elastic element of FIG. 10a.

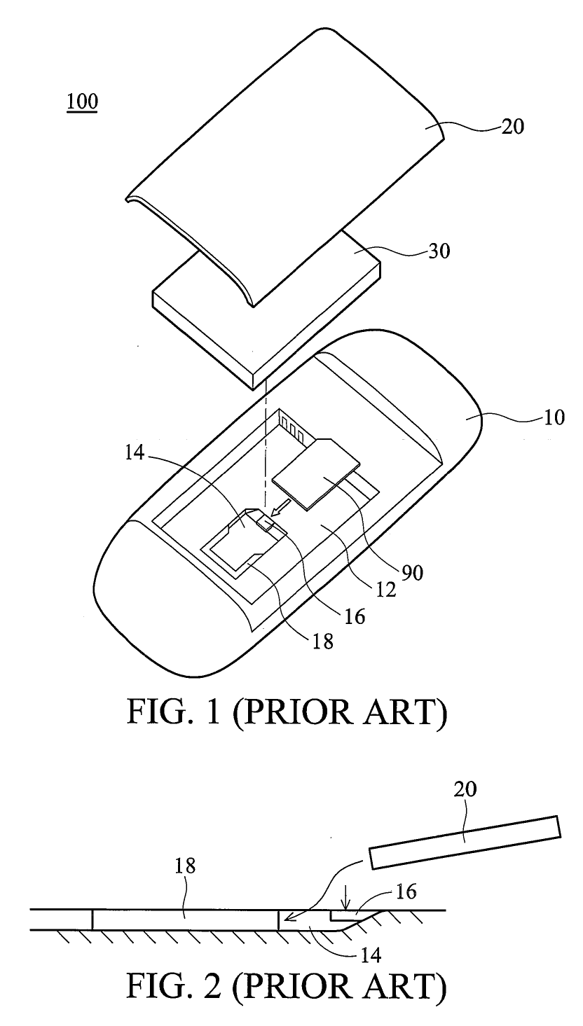

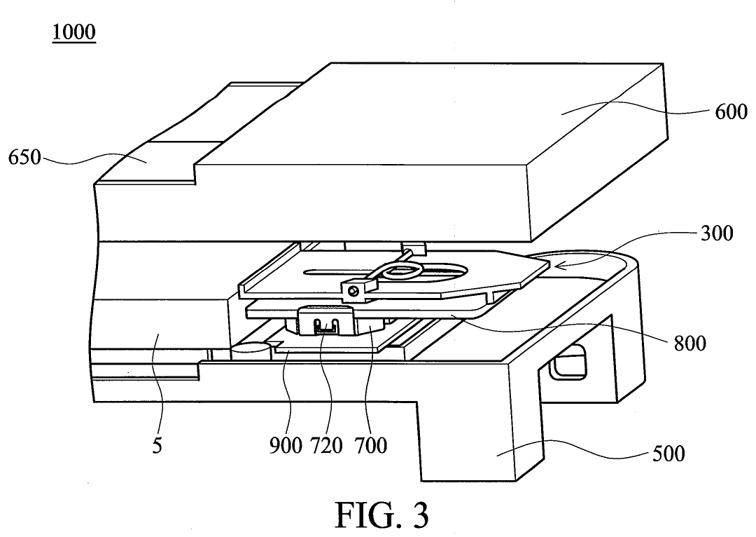

### DETAILED DESCRIPTION OF INVENTION

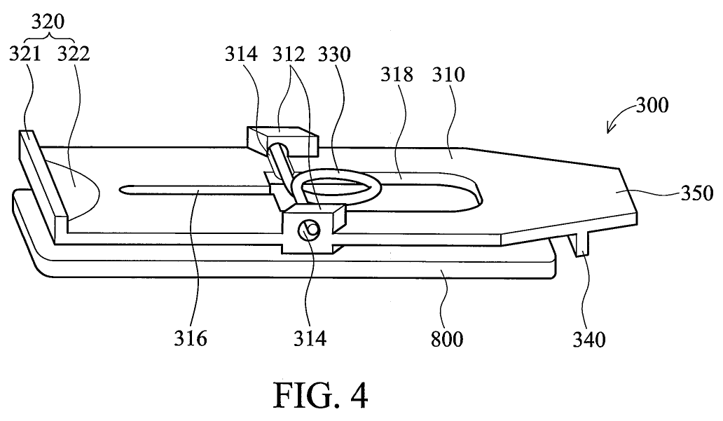

Referring to FIG. 3, a mobile phone 1000 comprises a body having a front frame 500 and a back cover 600 covering the front frame 500. A battery 5 is disposed in a battery room 650. A circuit board 900 is disposed besides the battery 5. A socket 700 is disposed on the circuit board 900 to receive an information store card 800. The socket 700 is joined to the circuit board 900 by SMT. The socket 700 has a slot 720 into which the information store card is inserted.

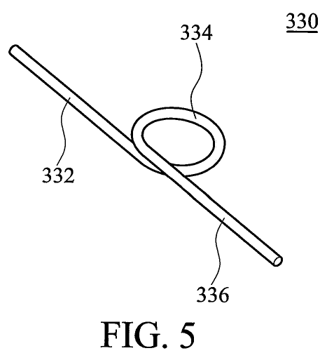

An information store card drawing mechanism (hereinafter drawing mechanism) 300 is disposed above the socket 700 as shown in FIG. 4. The drawing mechanism 300 comprises a main body 310, a drawing portion 320, an elastic element 330, a hook 340 and a tail portion 350. The main body 310 is plate-shaped and comprises a groove 316 and a recess 318 connected to the groove 316. A drawing portion 320 disposed on one side of the main body 310 comprises a flange 321 projected from and perpendicular to the main body 310 and a depression 322 adjacent to the flange 321 for easily grabbing. The hook 340 is disposed on another side of the main body 310 opposite to the drawing portion 320. The hook 340 projects from the main body 310 and extends toward the information store card 800. When the main body 310 moves, the information store card 800 is drawn.

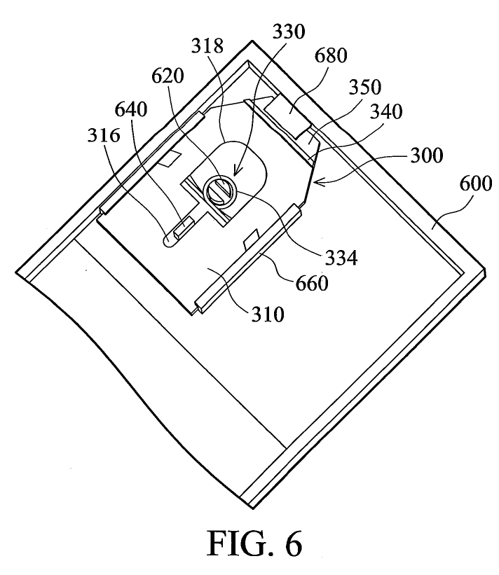

Two blocks 312 is disposed on two sides of the main body 310. Each block 312 has a through hole 314. Two ends of the elastic element 330 are inserted into the through holes 314 respectively, whereby the elastic element 330 is positioned on the main body 310. The elastic element 330 is formed by bending a wire, as shown in FIG. 5, comprises a first linear portion 332, a ring portion 334 and a second linear portion 336. The ring portion 334 connects the first and second linear portions 332 and 336 and positioned between the first and second linear portions 332 and 336. The first linear portion 332 and the second linear portion 336 are inserted into the through hole 314. The ring portion 334 is joined to a positioning element 620 on the back cover 600.

Referring to FIG. 3 again, when the drawing mechanism 300 assembled to a mobile phone 1000, it is disposed on the back cover 600. When the back cover 600 covers the front frame 500, the drawing mechanism 300 is positioned above the socket 700.

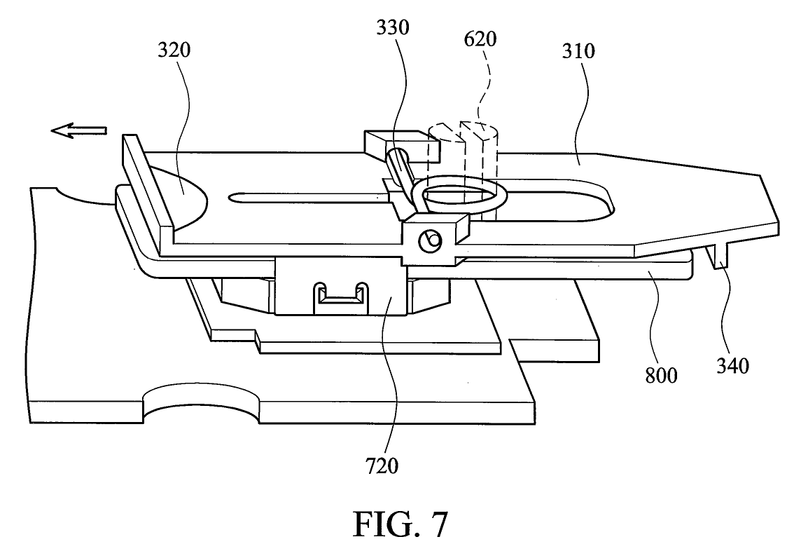

FIG. 6 depicts the drawing mechanism 300 assembled to the back cover 600. The back cover 600 has a positioning element 620, a protrusion 640, a pair of tracks 660 and a channel 680. The positioning element 620 is substantially a cylinder and projects from the inner side of the back cover 600. The protrusion 640 corresponds to the groove 316. The track 660 is C-shaped. When the drawing mechanism 300 is disposed on the back cover 600, two sides of the main body 310 enter the track 660, whereby the tracks 660 guide the main body 310 to slide on the back cover 600. The ring portion 334 of the elastic element 330 is joined to the cylindrical positioning element 620 which extends into the recess 318 so that the positioning element 620 does not obstruct the main body 310.

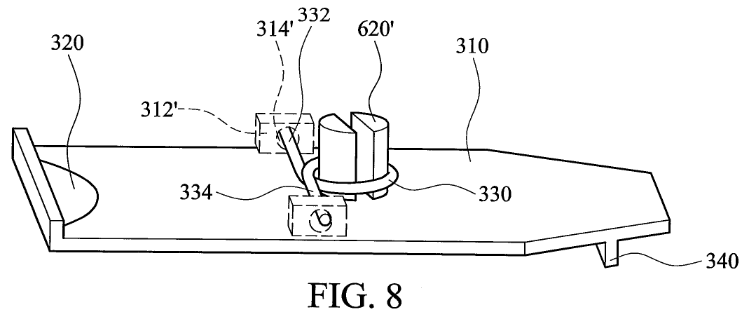

Referring to FIG. 3 again, the drawing mechanism 300 is assembled to the back cover 600 and revealed from the battery room 650. When the drawing portion 320 is pulled, as shown in FIG. 7, the main body 310 moves along the tracks 660 (as shown in FIG. 6). At this time, as the first and second linear portions 332 and 336 are fixed to the main body 310 and the ring portion 334 is joined to the back cover 600 (in FIG. 7, only the positioning element 620 is shown for the sake of clarity), the elastic element 330 has a potential on the main body 310. When the main body 310 moves along the tracks 660, the hook 340 pushes the information store card 800 to move the information store card 800 along the slot 720 until the potential balances the force exerted on the drawing portion 320. When the drawing portion 320 is released, the potential return the main body 310 to an original position. At this time, a part of the information store card 800 is revealed from the battery room 650, and the information store card 800 can be drawn out of the slot 720. When the main body 310 returns to the original position, the tail portion 350 engages the channel 680 to position the main body 310, as shown in FIG. 6. In another aspect, the main body 310 can reach and be positioned in the original position by the protrusion 640 abutting the groove 316.

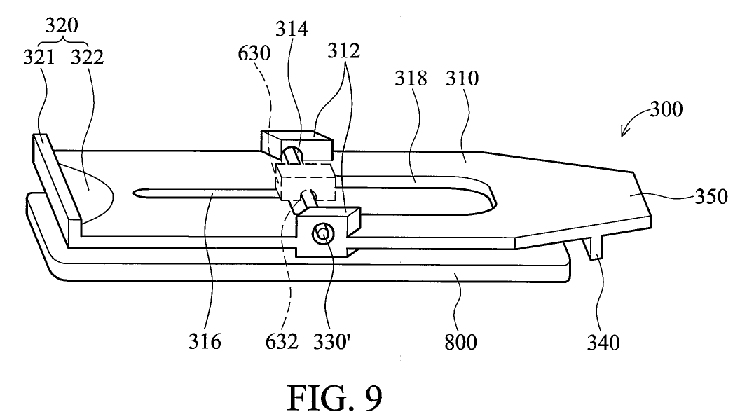

FIG. 8 depicts another embodiment of the drawing mechanism of the invention. In this embodiment, the cylinder positioning element 620′ is disposed on the main body 310, and the blocks 312′ are disposed on the back cover 600. The first and second linear portions 332 and 336 are inserted into through holes 314′ and the ring portion 334 is joined to the positioning element 620′, whereby the first and second linear portions 332 and 336 are joined to the back cover 600, and the ring portion 334 is joined to the main body 310.

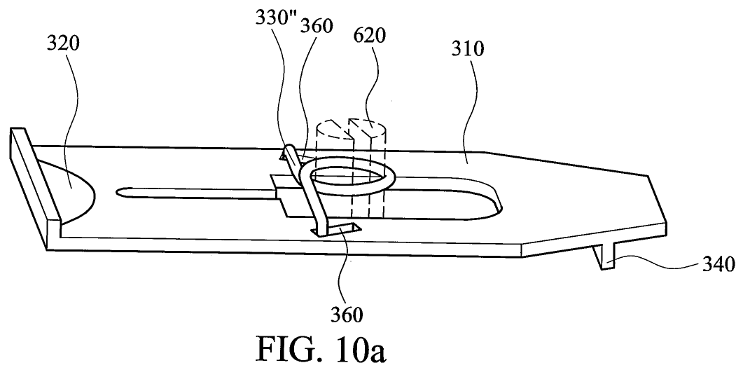

FIG. 9 depicts another embodiment of the drawing mechanism of the invention. In this embodiment, an elastic element 330′ is a linear element with two ends inserted into the through holes 314 and the middle portion engaging a positioning element 630 disposed on the back cover 600. The positioning element 630 has a slit 632 with which the middle portion of the elastic element 330′ is engaged.

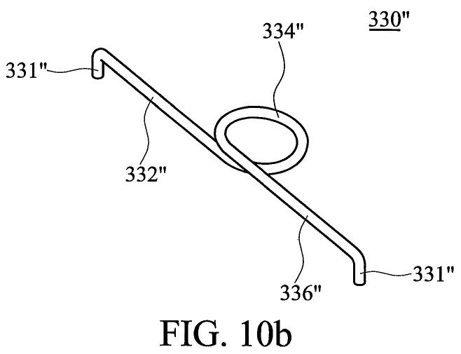

FIG. 10a depicts another embodiment of the drawing mechanism of the invention. In this embodiment, two slant holes 360 replaces the through holes 314 in the previous embodiment. An elastic element 330″ comprises a first linear portion 332″, a ring portion 334″, a second linear portion 336″ and two engaging portion 331″. The engaging portion 331″ is hook-shaped and inserted into the through hole 360 constraining the elastic element 330″

Although a mobile phone is described for the embodiment of the drawing mechanism of the invention, the invention is not limited thereto. The invention can also be applied to a personal digital assistant or a handheld media player.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An information store card drawing mechanism for a mobile device, comprising
a main body;
a drawing portion disposed on the main body;
a hook extending from the main body and the mobile device;
an elastic element connecting the main body and the mobile device; and
a track disposed on the mobile device, wherein the main body is guided by the track and when the drawing portion is pulled from an original position, the main body slides along the track and the hook pushes and moves the information store card, and when the drawing portion is released, the elastic element returns the main body to the original position.

2. The information store card drawing mechanism as claimed in claim 1, wherein the elastic element is formed by a wire with two ends joined to the main body and a middle portion joined to the mobile device.

3. The information store card drawing mechanism as claimed in claim 2, wherein the wire is linear.

4. The information store card drawing mechanism as claimed in claim 2, wherein the wire has a first linear portion, a second linear portion and a ring portion connecting the first and second linear portions and positioned therebetween, and the mobile device comprises a positioning element joined to the ring portion, and the main body has two through holes into which the first and second linear portions are inserted.

5. The information store card drawing mechanism as claimed in claim 4, wherein the main body has a recess accommodating a part of the positioning element.

6. The information store card drawing mechanism as claimed in claim 2, wherein the main body has two through hole into which two ends of the wire are inserted.

7. The information store card drawing mechanism as claimed in claim 1, wherein the elastic element is formed by a wire with two ends joined to the mobile device and a middle portion joined to the main body.

8. The information store card drawing mechanism as claimed in claim 7, wherein the wire is linear.

9. The information store card drawing mechanism as claimed in claim 7, wherein the wire has a first linear portion, a second linear portion and a ring portion connecting the first and second linear portions and positioned therebetween, and the main body comprises a positioning element joined to the ring portion, and the mobile device has two through holes into which the first and second linear portions are inserted.

10. The information store card drawing mechanism as claimed in claim 9, wherein the mobile device has a recess accommodating a part of the positioning element.

11. The information store card drawing mechanism as claimed in claim 7, wherein the mobile device has two through hole into which two ends of the wire are inserted.

12. The information store card drawing mechanism as claimed in claim 1, wherein the main body is plate-shaped, and the drawing portion and the hook are disposed on opposite sides of the main body.

13. The information store card drawing mechanism as claimed in claim 1, wherein the hook extends toward the information store card.

14. The information store card drawing mechanism as claimed in claim 1, wherein the main body has at least one groove and the mobile device has a protrusion engaging the groove, and the groove slides relative to the protrusion.

15. The information store card drawing mechanism as claimed in claim 14, wherein the groove has an end portion, and when the main body returns to the original position, the protrusion abuts the end portion.

16. The information store card drawing mechanism as claimed in claim 1, wherein the main body has a tail portion adjacent to the hook, and the mobile device has a channel, and when the main body returns to the original position, the tail portion enters the channel.

17. A mobile phone, comprising:
a body;
a socket disposed on the body to accommodate an information store card; and
a drawing mechanism disposed above the socket, comprising:
a drawing portion disposed on the main body;
a hook extending from the main body and the body;
an elastic element connecting the main body and the body; and
a track disposed on the body, wherein the main body is guided by the track and when the drawing portion is pulled from an original position, the main body slides along the track and the hook pushes and moves the information store card, and when the drawing portion is released, the elastic element returns the main body to the original position.

18. The mobile phone as claimed in claim 17, wherein the elastic element is formed by a wire with two ends joined to the main body and a middle portion joined to the body.

19. The mobile phone as claimed in claim 18, wherein the wire has a first linear portion, a second linear portion and a ring portion connecting the first and second linear portions and positioned therebetween, and the body comprises a positioning element joined to the ring portion, and the main body has two through holes into which the first and second linear portions are inserted.

20. A mobile phone, comprising:
a body;
a socket disposed on the body to accommodate an information store card; and
a information store card drawing mechanism as claimed in claim 1 disposed above the socket.
